(19) United States
(12) Patent Application Publication
(10) Pub. No.: US 2006/0203829 A1
(43) Pub. Date: Sep. 14, 2006

(54) Network support for hand-off between fixed and wireless networks for high-speed data applications

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/065,910

(22) Filed: Feb. 25, 2005

(51) Int. Cl. H04L 12/56

(52) U.S. Cl. 370/401

(57) ABSTRACT

An apparatus in one example has: a home fixed wireless data access service having a coverage area and at least one mobile wireless data service having a coverage area; a mobile terminal associated with the home fixed wireless data access service; an active wireless data connection for a data application between the mobile terminal to a one of the home fixed wireless data access service and the mobile wireless data service; and an automatic hand off process for the active wireless data connection of the one of the home fixed wireless data access service and the mobile wireless service, when the mobile terminal moves into the other of the home fixed wireless high access service and the mobile wireless service to allow the data application to continue without interruption.

### TECHNICAL FIELD

The invention relates generally to handing-off wireless high-speed data calls and more particularly to handing-off wireless high-speed data calls between traditional mobile wireless networks and the emerging fixed wireless high-speed data networks.

### BACKGROUND

Typically, a wireless switching center, which also may be known as a mobile switching center or mobile telephone switching office, is connected to a plurality of base stations that are dispersed throughout the geographic region serviced by the system and to the local and long-distance telephone and data networks. A wireless switching center is responsible for, among other things, establishing and maintaining a call between a first wireless terminal and a second wireless terminal or, alternatively, between a wireless terminal and a wireline terminal, which is connected to the system via the local and/or long-distance networks.

The geographic region serviced by a wireless telecommunications system is partitioned into a number of spatially distinct areas called “cells.” Typically, each cell contains a base station, which has the radios and antennas that the base station uses to communicate with the wireless terminals in that cell and also has the transmission equipment that the base station uses to communicate with the wireless switching center.

For example, when a user of a first wireless terminal desires to transmit information to a user of a second wireless terminal, the first wireless terminal transmits a data message bearing the user's information to the base station. The data message is then relayed by the base station to the wireless switching center. Because the first wireless terminal is in the cell serviced by the base station, the wireless switching center returns the data message back to the base station, which relays it to the second wireless terminal.

Typically, a wireless terminal communicates with the base station that is nearest to it. But because a wireless terminal can move from cell to cell, the base station that the wireless terminal is nearest to can change. Therefore, a wireless terminal usually communicates with different base stations as it moves from cell to cell. The process in which a wireless terminal ends communication with one base station and begins communication with another may be defined as a “hand off.”

Although there are several techniques in the prior art for performing a hand off, all of the techniques are similar in that they attempt to orchestrate the process so deftly that there is no perceptible interruption in service.

One technique in the prior art for performing a hand is known as “hard hand off.” Before a hard hand off, a wireless terminal uses one pair of communications channels (one for transmitting, the other for receiving) for communicating with a first base station. At the moment when the wireless terminal exits the cell serviced by the first base station and enters the cell serviced by a second base station, the wireless terminal re-tunes its radio from the first pair of communications channels to a second pair of communications channels for communicating with a second base station. Furthermore, at the same moment that the wireless terminal re-tunes its radio, the wireless switching center stops using the first base station for communication with the wireless terminal and begins using the second base station.

A second technique in the prior art for handing off a wireless terminal is known as “soft hand off.” Before a soft hand off, a wireless terminal uses one pair of communications channels (one for transmitting, the other for receiving) for communicating with a first base station. Before the wireless terminal exits the cell serviced by the first base station and enters the cell serviced by the second base station, the wireless terminal begins communications with the second base station on a second pair of channels. Thereafter, the wireless terminal communicates with both base stations on different pairs of channels until the wireless terminal ends communication with the first base station.

The salient difference between hard hand off and soft hand off is that with soft hand off there is no single moment when the wireless terminal stops using one base station and begins using the second. Rather, with soft hand off there is a significant interval (e.g., a few seconds or more) when the wireless terminal communicates with two base stations at the same time. In contrast, with hard hand off, there is no time when the wireless terminal communications with two base stations at the same time.

High-speed data applications are an important feature of third generation wireless networks. More and more applications are taking advantage of these network's ability to provide fast, seamless data connections over the mobile coverage area. An emerging Internet access technology is fixed wireless access, which is generally intended to provide an alternative to cable modem and digital subscriber line high-speed Internet access to the subscriber's home.

However, there is a need in the art for the ability to perform an automatic handoffof a mobile wireless high-speed data call to a subscriber's fixed wireless service when the user moves within range of that service's coverage. Conversely, there is also a need for the ability to automatically hand-off an active connection to the subscriber's mobile wireless data network from the subscriber's fixed wireless high-speed data service when the subscriber moves out of their fixed wireless coverage area.

### SUMMARY

The invention in one implementation encompasses an apparatus. The apparatus may comprise: a home fixed wireless data access service having a coverage area and at least one mobile wireless data service having a coverage area; a mobile terminal associated with the home fixed wireless data access service; an active wireless data connection for a data application between the mobile terminal to a one of the home fixed wireless data access service and the mobile wireless data service; and an automatic hand off process for the active wireless data connection of the one of the home fixed wireless data access service and the mobile wireless service, when the mobile terminal moves into the other of the home fixed wireless high access service and the mobile wireless service to allow the data application to continue without interruption.

Another implementation of the invention encompasses a method. The method may comprise: establishing for a data application an active wireless data connection from a mobile terminal to a one of a home fixed wireless data access service and a mobile wireless data service; and automatically handing off the active wireless data connection of the one of the home fixed wireless data access service and the mobile wireless service, when the mobile terminal moves into the other of the home fixed wireless high access service and the mobile wireless service to allow the data application to continue without interruption.

### DESCRIPTION OF THE DRAWINGS

Features of exemplary implementations of the invention will become apparent from the description, the claims, and the accompanying drawings in which:

FIG. 1 is a representation of one implementation of an apparatus for handing-off wireless high-speed data calls between traditional mobile wireless networks and the emerging fixed wireless high-speed data networks.

FIG. 2 is a representation of another implementation of an apparatus for handing-off wireless high-speed data calls in a direction opposite to that depicted in FIG. 1.

FIG. 3 is a flow diagram of one implementation of the method for handing-off wireless high-speed data calls between traditional mobile wireless networks and the emerging fixed wireless high-speed data networks.

FIG. 4 is a flow diagram of another implementation of the method for handing-off wireless high-speed data calls between traditional mobile wireless networks and the emerging fixed wireless high-speed data networks.

FIG. 5 is a flow diagram of a further implementation of the method for handing-off wireless high-speed data calls between traditional mobile wireless networks and the emerging fixed wireless high-speed data networks.

### DETAILED DESCRIPTION

In one implementation an active wireless data connection may be automatically handed off to the subscriber's home fixed wireless high-speed data access service when the caller moves into the fixed wireless coverage area allowing the data application to continue without interruption. This hand-off takes advantage of the higher speeds and lower access rates that are projected to be available on the fixed wireless access networks.

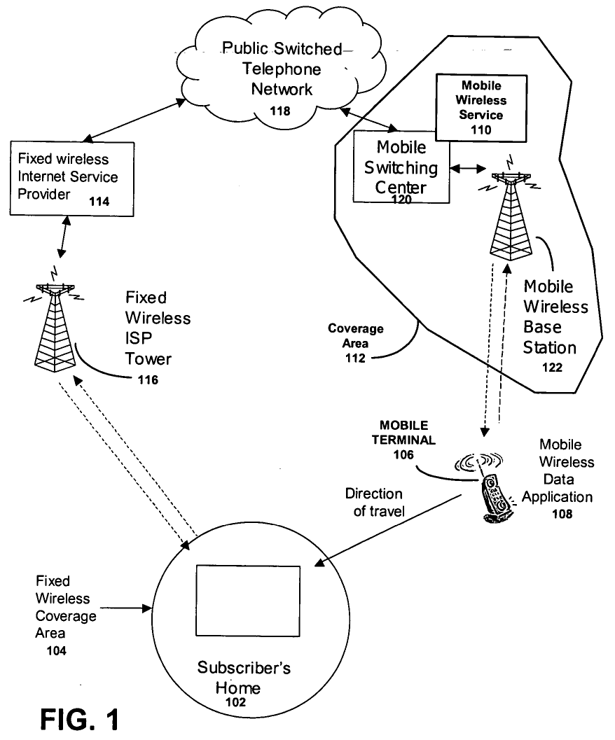

Turning to FIG. 1, an apparatus 100 in one example may comprise a home fixed wireless data access service 102 having a coverage area 104 and at least one mobile wireless data service 110 having a coverage area 112. A mobile terminal 106 is associated with the home fixed wireless data access service 102. The mobile terminal 106 may be a cellular phone, a personal digital assistant, a laptop computer, etc. An active wireless data connection for a data application 108 may exist between the mobile terminal 106 and one of the home fixed wireless data access service 102 and the mobile wireless data service 110. When the mobile terminal 106 moves from one to the other of the coverage area 104 of the home fixed wireless high access service 102 and the coverage area 112 of the mobile wireless service 110, an automatic hand off process for the active wireless data connection allows the data application to continue without interruption.

More specifically, FIG. 1 depicts the scenario when the mobile terminal 106 moves from the coverage area 112 of the mobile wireless service 110 to the coverage area 104 of the home fixed wireless high access service 102. The home fixed wireless high access service 102 is operatively coupled to a fixed wireless Internet service provider (ISP) 114 having a fixed wireless ISP tower 116. The ISP 114 may be operatively coupled to a public switched telephone network 118. The public switched telephone network 118 may also be operatively coupled to a mobile switching center 120 that is operatively coupled to a mobile wireless base station 122.

When the mobile terminal 106 is located in the coverage area 112, the mobile terminal 106 wirelessly communicates with the mobile switching center 120 via the mobile wireless base station 122. When the mobile terminal 106 moves out of the coverage area 112 and into the coverage area 104, the mobile terminal 106, the home fixed wireless data access service 102 and the fixed wireless Internet service provider 114 coordinate the hand-off of the mobile data application 108 from the mobile wireless service 110 to the fixed wireless network 102.

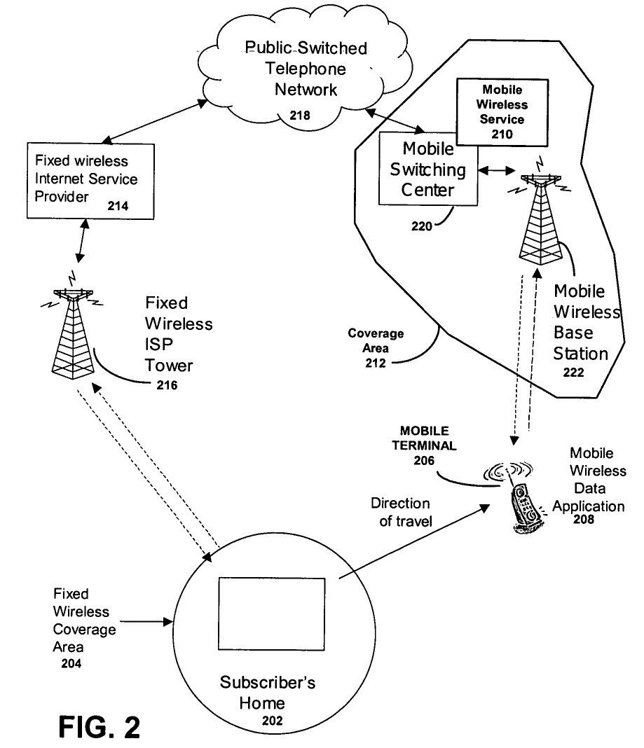

Turning to FIG. 2 (which essentially corresponds to the FIG. 1 implementation), an apparatus 200 in one example may comprise a home fixed wireless data access service 202 having a coverage area 204 and at least one mobile wireless data service 210 having a coverage area 212. A mobile terminal 206 is associated with the home fixed wireless data access service 202. An active wireless data connection for a data application 208 may exist between the mobile terminal 206 and one of the home fixed wireless data access service 202 and the mobile wireless data service 210. When the mobile terminal 206 moves from one to the other of the coverage area 204 of the home fixed wireless high access service 202 and the coverage area 212 of the mobile wireless service 210, an automatic hand off process for the active wireless data connection allows the data application to continue without interruption.

More specifically, FIG. 2 depicts the scenario when the mobile terminal 206 moves from the coverage area 212 of the home fixed wireless high access service 202 to the coverage area 204 of the mobile wireless service 210. The home fixed wireless high access service 202 is operatively coupled to a fixed wireless Internet service provider 214 having a fixed wireless ISP tower 216. The ISP 214 may be operatively coupled to a public switched telephone network 218. The public switched telephone network 218 may also be operatively coupled to a mobile switching center 220 that is operatively coupled to a mobile wireless base station 222.

When the mobile terminal 206 is located in the coverage area 204, the mobile terminal 206 wirelessly communicates with the home fixed wireless data access service 202. When the mobile terminal 206 moves out of the coverage area 204 and into the coverage area 212, the mobile terminal 206, the home fixed wireless data access service 202 and the fixed wireless Internet service provider 214 coordinate the hand-off of the mobile data application 208 from the fixed wireless network 202 to the mobile wireless service 210.

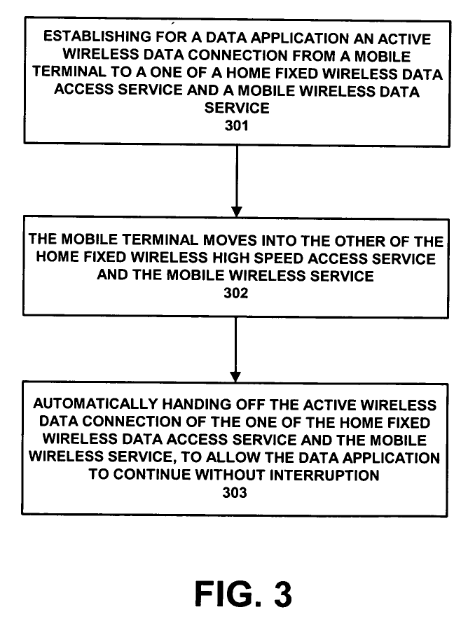

FIG. 3 is a flow diagram of one implementation of the method for handing-off wireless high-speed data calls between traditional mobile wireless networks and the emerging fixed wireless high-speed data networks. The method may comprise: establishing for a data application an active wireless data connection from a mobile terminal to a one of a home fixed wireless data access service and a mobile wireless data service (301); and, when the mobile terminal moves into the other of the home fixed wireless high access service and the mobile wireless service (302), automatically handing off the active wireless data connection of the one of the home fixed wireless data access service and the mobile wireless service, to allow the data application to continue without interruption (303).

In one implementation charges for minutes used on the wireless network may be billed in a same known manner as minutes used on the home fixed wireless network.

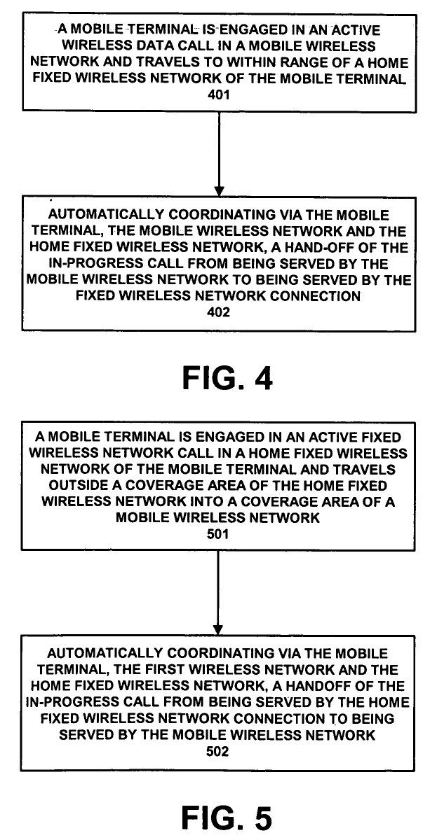

FIG. 4 is a flow diagram of another implementation of the method for handing-off wireless high-speed data calls between traditional mobile wireless networks and the emerging fixed wireless high-speed data networks. This implementation of the method may comprise, when a mobile terminal is engaged in an active wireless data call in a mobile wireless network and travels to within range of a home fixed wireless network of the mobile terminal (401), automatically coordinating via the mobile terminal, the mobile wireless network and the home fixed wireless network, a hand-off of the in-progress call from being served by the mobile wireless network to being served by the fixed wireless network connection (402).

FIG. 5 is a flow diagram of a further implementation of the method for handing-off wireless high-speed data calls between traditional mobile wireless networks and the emerging fixed wireless high-speed data networks. This implementation of the method may comprise, when a mobile terminal is engaged in an active fixed wireless network call in a home fixed wireless network of the mobile terminal and travels outside a coverage area of the home fixed wireless network into a coverage area of a mobile wireless network (501), automatically coordinating via the mobile terminal, the first wireless network and the home fixed wireless network, a handoff of the in-progress call from being served by the home fixed wireless network connection to being served by the mobile wireless network (502).

The apparatus in one example may comprise a plurality of components such as one or more of electronic components, hardware components, and computer software components. A number of such components can be combined or divided in the apparatus. The apparatus in one example employs one or more computer-readable signal-bearing media. The computer-readable signal-bearing media store software, firmware and/or assembly language for performing one or more portions of one or more embodiments. Examples of a computer-readable signal-bearing medium for the apparatus may comprise a recordable data storage medium. In another example,. the computer-readable signal-bearing medium comprises a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified. Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a home fixed wireless data access service having a coverage area and at least one mobile wireless data service having a coverage area;
a mobile terminal associated with the home fixed wireless data access service;
an active wireless data connection for a data application between the mobile terminal to a one of the home fixed wireless data access service and the mobile wireless data service; and
an automatic hand off process for the active wireless data connection of the one of the home fixed wireless data access service and the mobile wireless service, when the mobile terminal moves into the other of the home fixed wireless high access service and the mobile wireless service to allow the data application to continue without interruption.

2. The apparatus of claim 1 wherein the mobile terminal is a cellular phone.

3. The apparatus of claim 1 wherein the mobile terminal is a personal digital assistant.

4. The apparatus according to claim 1, wherein the home fixed wireless data access service is a high-speed data access service.

5. The apparatus according to claim 1, wherein the mobile wireless data access service is a high-speed data access service.

6. A method, comprising the steps of:
establishing for a data application an active wireless data connection from a mobile terminal to a one of a home fixed wireless data access service and a mobile wireless data service; and
automatically handing off the active wireless data connection of the one of the home fixed wireless data access service and the mobile wireless service, when the mobile terminal moves into the other of the home fixed wireless high access service and the mobile wireless service to allow the data application to continue without interruption.

7. The method according to claim 6, wherein charges for minutes used on the wireless network are billed in a same manner as minutes used on the home fixed wireless network.

8. The method according to claim 6, wherein the home fixed wireless data access service is a high-speed data access service.

9. The method according to claim 6, wherein the mobile wireless data access service is a high-speed data access service.

10. The method of claim 6 wherein the mobile terminal is a cellular phone.

11. The method of claim 6 wherein the mobile terminal is a personal digital assistant.

12. A method, comprising the steps of:
automatically coordinating, when a mobile terminal is engaged in an active wireless data call in a mobile wireless network and travels to within range of a home fixed wireless network of the mobile terminal, via the mobile terminal, the mobile wireless network and the home fixed wireless network, a hand-off of the in-progress call from being served by the mobile wireless network to being served by the fixed wireless network connection.

13. The method according to claim 12, wherein charges for minutes used on the mobile wireless network are billed in a same manner as minutes used on the home fixed wireless network.

14. The method according to claim 12, wherein the home fixed wireless data access service is a high-speed data access service.

15. The method according to claim 12, wherein the mobile wireless data access service is a high-speed data access service.

16. The method of claim 12 wherein the mobile terminal is a cellular phone.

17. The method of claim 12 wherein the mobile terminal is a personal digital assistant.

18. A method, comprising the steps of:
automatically coordinating, when a mobile terminal is engaged in an active fixed wireless network call in a home fixed wireless network of the mobile terminal and travels outside a coverage area of the home fixed wireless network into a coverage area of a mobile wireless network, via the mobile terminal, the first wireless network and the home fixed wireless network, a handoff of the in-progress call from being served by the home fixed wireless network connection to being served by the mobile wireless network.

19. The method according to claim 18, wherein charges for minutes used on the mobile wireless network are billed in a same manner as minutes used on the home fixed wireless network.

20. The method according to claim 18, wherein the home fixed wireless data access service is a high-speed data access service.

21. The method according to claim 18, wherein the mobile wireless data access service is a high-speed data access service.

22. The method of claim 18 wherein the mobile terminal is a cellular phone.

23. The method of claim 18 wherein the mobile terminal is a personal digital assistant.
